(19) United States
(12) Patent Application Publication
(10) Pub. No.: US 2025/0015568 A1
(43) Pub. Date: Jan. 9, 2025

(54) A TEMPORARY FASTENING AND PULL IN TOOL FOR A POWER UMBILICAL

(71) Applicant: AKER SOLUTIONS AS, Lysaker (NO)

(72) Inventors: Arild FIGENSCHOU, Billingstad (NO); Daniel HATFIELD, Heggedal (NO); Tor Erling RUUD, Nittedal (NO)

(21) Appl. No.: 18/708,380

(22) PCT Filed: Nov. 7, 2022
(86) PCT No.: PCT/EP2022/080966

§ 371 Date: May 8, 2024

(30) Foreign Application Priority Data
Nov. 9, 2021 (NO) 20211351

(51) Int. Cl. H02G 1/08; H02G 1/10; H02G 15/013

(52) U.S. Cl. CPC H02G 1/081; H02G 1/10; H02G 15/013

(57) ABSTRACT

A temporary fastening and pull in tool for a power umbilical to be installed at an offshore facility, such as a wind generator facility, is presented. The power umbilical has an outer sheath surrounding a power core and two rods. The tool comprises a packer assembly for sealing and giving mechanical support around a portion of the sheath situated at or near a free end portion of the power umbilical. A load bearing arrangement connects to the packer assembly adapted to receive an end portion of the rods. A fastener secures the rods to the load bearing arrangement. A lifting device is attached to the load bearing arrangement for guiding the power umbilical to the offshore facility and ease the pull in operations of the power umbilical.

### TECHNICAL FIELD

The invention relates to a tool and a method for installation of power cables on an offshore facility. More particularly, the system is a temporary tool for pulling in the power cable or umbilical for temporary installment on the offshore facility. The method includes the assembly of the tool and the method for installing the power cable or power umbilical. The method and system are particularly suitable for a power cable or power umbilical for use in wind power platform.

### BACKGROUND ART

Traditionally, power cables or power umbilicals provide a link between surface and seafloor equipment for control, power, or heat. They provide electric and fiber-optic signals, electrical power, and hydraulic and chemical injection fluids to the subsea unit. They can also power subsea boosting and compression, as well as provide flow-line heating to prevent the formation of wax and hydrates that could slow oil production.

In the growing demand for renewable energy sources, the power cables or power umbilical are also useful for wind energy platforms.

The wind energy platforms are typically arranged in clusters made of by a plurality of wind generators. To connect the wind generators, there are arranged interconnection power cables, so called array cables. The array cables are thus power cables or umbilicals that are arranged between different wind generator facilities or linking the individual wind generator to a substation at the seabed.

The power cables or umbilicals that traditionally are installed in offshore facilities are power cables or umbilicals must be precut into the desired length for installation at an onshore facility. In general, these types of power cables or umbilicals utilize the soft clamp hang-off system where there are arranged frictional spots arranged in intervals in the longitudinal direction of the umbilical. An example of these type of power cables are described in publication U.S. Pat. No. 8,723,030. Due to the physical structure of the soft clamp cables, these requires pre-termination of the cable.

A different types of power cables, called soft grip cables are under development. These have a different physical structure and allows the cables to be cut in a required length directly on the installation vessel. An example of a soft grip cable is shown in FIG. 1 and further described in relation to this figure.

These types of power cables may for instance be advantageous in clusters of wind farms, where there are arranged a plurality of wind turbine installations and where there is a need for installation of power cables between each of the wind turbine installation.

In oppose to the Soft Clamp power cable or umbilical that needs to be terminated on shore, the main feature of the Soft Grip power cable or umbilical allows a flexibility to cut the cable length offshore and to enable easy pull in by a simplified system attached to a temporary hang-off.

Both types of power cable or umbilical are applicable for the tools and method according to the application and the invention is not limited to a particular power cable or umbilical

The installation is in general however advantageous for a power cable or power umbilical of the latter Soft Grip system type in that this type of power umbilical are more adaptable to any desired length on an installation vessel offshore without the need of being pre-cut to the required length at an onshore facility.

In big clusters the array cables have typically a big volume, ie a large cross sectional areas. This requires that the installation of the array cables must be optimized to both the time and vessel cost.

It is an object by the present invention to provide a simplified method and system that enables the installation of a power cable or umbilical on an offshore facility in an effectively and simple manner. This is especially useful in a system for installing several power cables or umbilicals, such as installation of power cables related to offshore wind generators or clusters of wind generators.

It is a goal to minimize the work and operations on the installation vessel as much as possible. Since this will require more operations on the offshore facility, it has also been of importance to keep the weight as low as possible on all the parts to avoid use of a crane.

Using a temporary clamp on the offshore facility while installing the permanent termination would not be applicable due to the size and weight of the temporary clamp.

There is thus a need for a simple temporary termination tool to be installed on the cable on the installation vessel.

It is a further a particular advantage of the present invention that the temporary termination work does not require any crane or similar. Instead, the work procedure requires only hand tools to be performed.

Further and other object of the invention will be apparent by the accompanying description and figures.

### SUMMARY OF INVENTION

The invention relates to a temporary fastening and pull in tool for a power umbilical adapted to be installed at an offshore facility, such as a wind generator facility, the power umbilical has an outer sheath surrounding at least one power core and at least two rods. The tool comprises
a packer assembly for sealing and to give mechanical support around the sheath of the power umbilical at a free end portion of the power umbilical, a load bearing arrangement connected to the packer assembly adapted to receive an end portion of the at least two rods,
a fastener adapted to secure each rod to the load bearing arrangement,
a lifting device attached to the load bearing arrangement for guiding the offshore facility and ease the pull in operations of the power umbilical.

Preferably, the lifting device is adapted to guiding the power umbilical through a J-tube of the offshore facility.

Preferably embodiments of the temporary fastening and pull in tool are set of in the accompanying dependent claims.

The invention further relates to a method for assembling the temporary fastening and pull in tool to perform a temporary pull in operation, wherein the method comprises the following sequential steps
removing the outer sheath from a free end portion of the power cable,
installing the packer assembly around the sheath of the power umbilical at the free end portion of the power umbilical,
attaching the load bearing arrangement to the packer assembly at the side facing the free end portion,
preparing the at least two rods for attachment to the load bearing arrangement,
securing the at least two rods to the load bearing arrangement,
installing a sealing device on the power core(s) and/or a fiberoptic cable arranged within the power umbilical to prevent water ingress,
attaching a lifting device to the load bearing arrangement and lifting the power umbilical with the pull in tool.

Preferable embodiments of the method are set out in the dependent claims.

The invention further relates to a method for permanently termination of a power umbilical in an offshore facility, such as an offshore wind generator, using the temporary fastening and pull in tool of the invention, wherein the method comprises
pulling-in the power to a tube where the power umbilical is adapted to be suspended,
installation of a hang off flange for permanently suspension of the power umbilical,
removal of the lifting device and cutting back components of the power umbilical, such as strands and filler material.

Preferable embodiment of the method of permanently termination are set out in the dependent claim

### BRIEF DESCRIPTION OF DRAWINGS

FIG. 1 shows a cross sectional view of an example power cable to be used in the present invention,

FIG. 2-18 illustrates the installation of the power cable from the preparation of the cable to the installment on site,

FIG. 2-12 shows the steps for preparing the power cable by connecting a pull in arrangement to the power cable or power umbilical,

FIG. 2 illustrating a free end of a power cable or power umbilical arranged as a continuous cable on a reel on an installation vessel,

FIG. 3 is illustrating the free end of the power cable or power umbilical where the outer sheeting of the free end has been stripped off to required pig tail length and for Boot seal installation,

FIG. 4 shows the installation of a lower packer ring on the stripped outer sheeting,

FIG. 5 shows the completion of the packer ring,

FIG. 6 shows the pulling out of the steel rods from U grooves at the side of the power cable or power umbilical,

FIG. 7-8 shows the installation of a canister on the power cable or power umbilical,

FIG. 9 shows the installation of a load ring on the power cable or power umbilical,

FIG. 10 shows the further installation of nuts on the threaded steel rods,

FIG. 11 shows further the installation of boots seals on the power cores,

FIG. 12 shows the installation of pull-in slings on the power cable or power umbilical,

FIG. 13-18 shows the sequential steps for pull in of the power cable or power umbilical to an offshore facility and the completion of the termination to permanent hang off.

FIG. 13 shows the power cable or power umbilical with the pull in sling arrangement pulled through a J-tube reaching the top of an I-tube,

FIG. 14 shows the installation of a split of hang off flange,

FIG. 15 shows the land out of the power cable or power umbilical on the I-tube.

FIG. 16 shows the removal of the pull in sling and filler element for termination preparation,

FIG. 17 shows a detailed view of the step where the steel strands have been cut to a required length,

FIG. 18-19 shows the steps of installing a first upper cannister and a second upper cannister onto the lower cannister.

### DETAILED DESCRIPTION OF THE INVENTION

The term “temporary fastening and pull in tool” is to be interpreted as a temporary arrangement that is adapted to be arranged on a power cable or umbilical to facilitate the installation of the power cable or umbilical at an offshore facility.

The term “offshore facility” is to be interpreted as an installation that are positioned offshore. This may for instance be wind turbines or cluster of wind turbines, wave power plant, platforms etc.

The term “power cable” or “power umbilical” is to be interpreted as a cable with a variety of elements or components bundled together with an outer sheath enclosing the components.

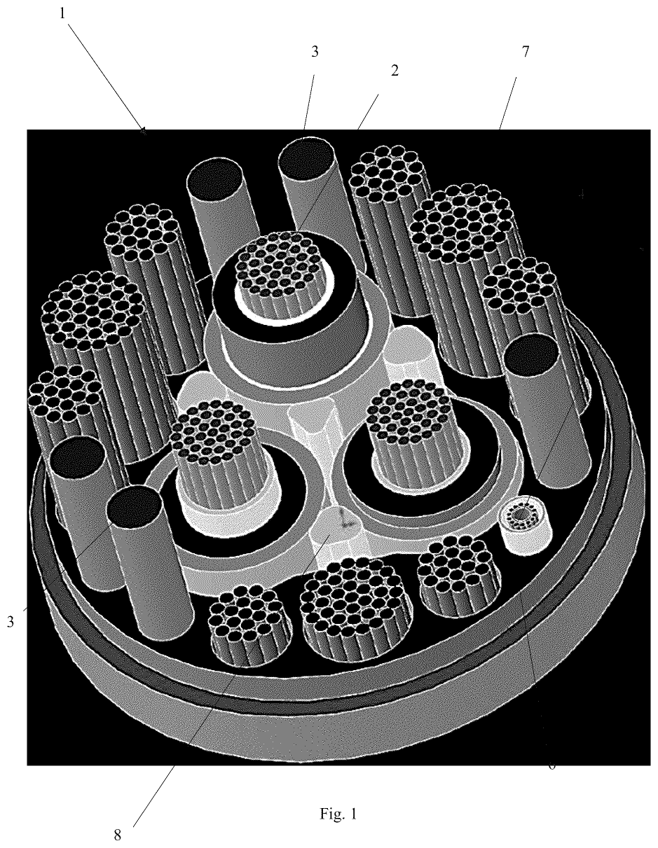

The term “cable components” is to be interpreted as the various elements that may be present in the power cable or umbilical. An illustrating example is shown in FIG. 1.

The components may for instance be a core 2, a rod 3, a bundle of strands 7, a fiber optic cable 5 and a flexible friction element 8. As shown in FIG. 1, there may also be several equal components in the power cable 1. In addition, there may be a filler material 6 surrounding the components. A sheath 4 is enclosing the components 2, 3, 5, 7 and the filler material 6.

The rods 3 and strands 7 may preferably be made of steel. The sheath 4 is preferably made of polyethylene. The filler material 6 may be made of polyvinylchloride and the flexible friction element 8 may be made of rubber.

This FIG. 1 shows an example embodiment of a power umbilical 1 according to the soft grip system. The soft grip system provides as previously mentioned an example cable or umbilical where the invention is usable. The SoftGrip system is previously described in the Norwegian applications 20210612 and NO20211281.

The outer sheath 4 of the power cable or power umbilical 1 may in this embodiment be made from plastic material, such as polyethylene that shrinks during extrusion. This induces a relatively high radial compression force on the internals of the cable or umbilical 1. This brings the filler material 6 or the PVC elements tightly together by a high force which also can have some variation in magnitude due to the diameter, thickness and set extrusion parameters. The internal filler material 6 which are squeezed together are designed to stop at a certain position. This position is secured by the designed geometry of the profiles. If the extrusion parameters are correctly set, the internal geometry is somewhat independent of the shrink force of the sheath 4.

In this position, when the profiles have come to the final stop, the filler material 6 in the cross section forms free holes for each of the power cores 2. These may be made of for instance polyvinylchloride, PVC. In oppose to the SoftClamp system which is an anchoring point for the power cores which needs to have a predefined position and length inside the power cable, the SoftGrip core anchoring system will be applied as a continuous element along the total length of the power cable. The SoftGrip gives a prescribed frictional effect to the power cores 2 sufficiently to terminate the cores but at a level which do not induce fatigue issues.

The required frictional effect is thus induced by flexible friction elements 8, such as thick-walled small diameter rubber houses. These elements are deformed in between the power cores and the filler material during the manufacturing process. By sizing the flexible elements correctly, the elements 8 respond with a prescribed and known contact force inducing a prescribed and known frictional effect on the power cores 2.

The internal frictional effect on the power cores is now tunable and controlled independent of the squeeze force from the outer jacket. The power cables or umbilical 1 may consequently be cut in any position.

As a preparation for the installation procedure, there should preferably be performed a fatigue check on the rods 3 in addition to a check of the frictional effect induced in a lifting process.

The rods 3 are preferably arranged in pairs, but the last rod 3 is arranged as a single rod when there is a fiberoptic cable 5 present in the umbilical 1. The rods 3 are disposed around the power umbilical 1. This is only a non-limiting example. Other number of rods 3 are also possible. However, there must be at least two rods 3. The weight of the power umbilical 1 is dependent on the strength of these rods 3 in the installation operation. An example diameter of the rods 3 may be 16 mm or 14 mm.

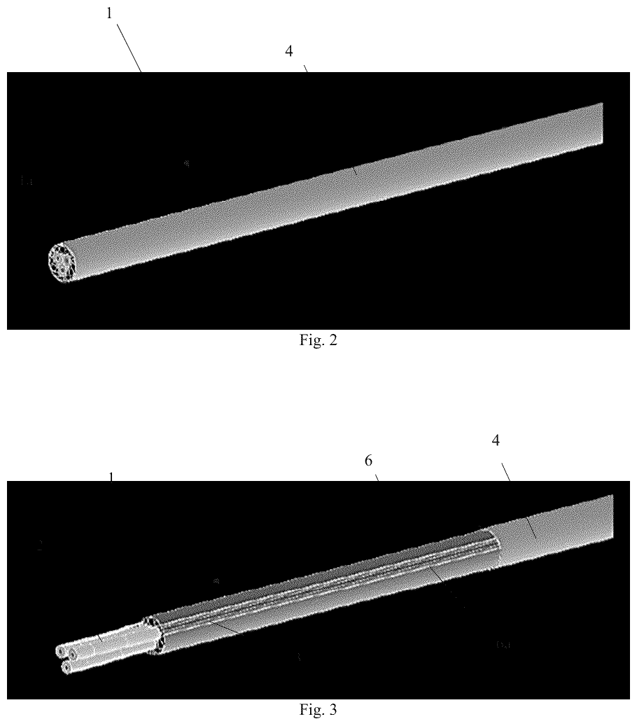

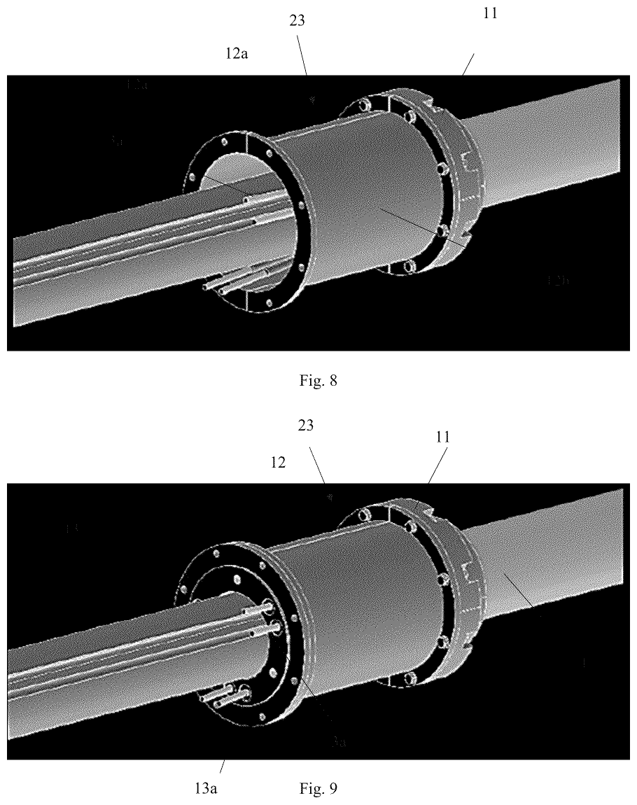

FIG. 2-13 shows an assembly of a temporary fastening and pull in tool 10, hereinafter called pull-in tool 10, onto a power umbilical 1. The figures illustrate sequential steps of preparation for the installation process and the assembly of the temporary fastening and pull in tool 10. The power umbilical 1 of the figure refers to the same reference number as the power umbilical 1 of FIG. 1. It is however to be noted that this is only an illustrating embodiment of the power cable or umbilical, any power umbilical 1 may be used as long as it has at least two rods 2 arranged within the power umbilical 1.

The following operations will be performed on an installation vessel prior to a lifting procedure:
removal of the outer sheath 4 on a part of the power cable 1. The removal is performed at the free end 1a of the power cable.
installing a packer assembly 11 and load bearing arrangement 23 on the power cable or umbilical 1.
installing water-tight sealing device on the power core 2 and/or the fiber optic cable 5 to whatever present in the umbilical 1 prevent water ingress during the pull in operation.
installing a protection cap or pull in sling 16 to apply the pull in load to the umbilical or cable 1. This is particularly beneficial through pull in operations through J-tubes as the pull-in sling guides the free end of the cable or umbilical through the J-tube. This will ease the entry during a pull in operation, such as through a J-tube pull-in operation.

FIG. 2 shows the free end 1a of the power cable or umbilical having an outer sheath 4 surrounding possible cable components 2, 3, 5, 6, 7

FIG. 3 shows the free end 1a of the power cable or umbilical 1 where the outer sheath 4 has been removed. The outer sheath 4 has been removed to be suitable for a required pig tail length.

The sheath 4 may for instance be removed about 2-3 meters measured from the free end 1a. The sheath may also be removed between 3-5 meters. This is however dependent on the required pig tail length. The removed portion is referred to as the free end portion 1b to indicate the area where the sheath 4 has been removed.

There may also be a removal of the filler material 6, strands 7, rods 3 and friction elements 8 at distance from the free end 1a as illustrated in the FIG. 3. This provides a fully exposal of the power cores 2 and/or the fiber optic cable 5, and possible other components of that are to be connected to the offshore facility or seabed installation.

This removal may also be adjusted to the length required for a sealing device 15 to protect the exposed components. FIG. 3 also discloses a removal of a part of the filler material 6 or polyvinylchloride (pvc) profiles that is arranged outside the rods 3. The removal results in a groove 6a in the filler material for each of the rods 3 present in the power cable 1.

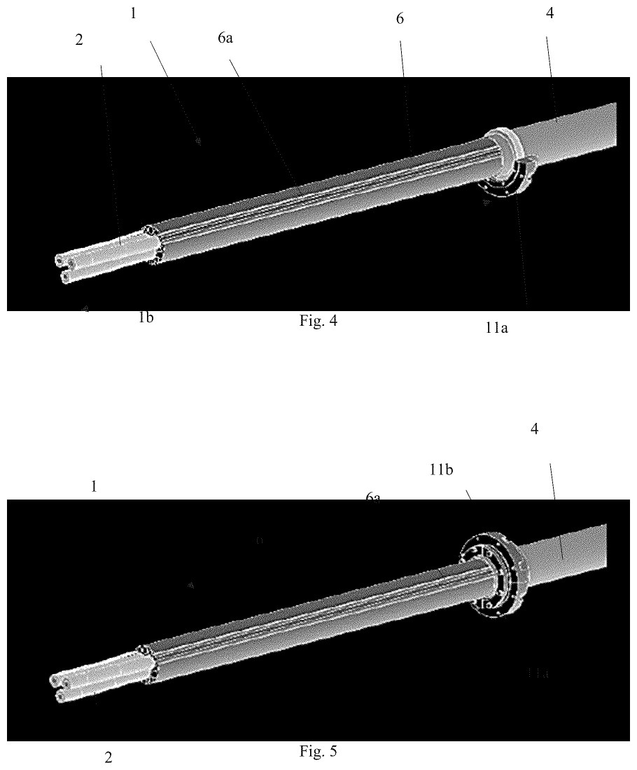

FIGS. 4-5 shows a first packer ring part 11a and a second packer ring part 11b and the installment of these on the power cable 1. As illustrated in the figures, the packer ring parts 11a, 11b may be installed as two half parts assembled onto the power cable and secured to each other and to the power cable 1.

For simplicity, the assembled packer ring parts 11a, 11b will hereinafter be referred to by reference number, as packer ring assembly 11.

The packer ring assembly 11 provides a sealing and a mechanical support around the sheath 4.

The packer ring assembly 11 is when connected to the cable or umbilical 1 arranged at a position where the sheath 4 has not been removed. The arrangement is however in the near proximity to the area where the sheath 4 has been removed from the power cable or umbilical 1 as illustrated in the figure. This part is referred to as the free end portion 1b.

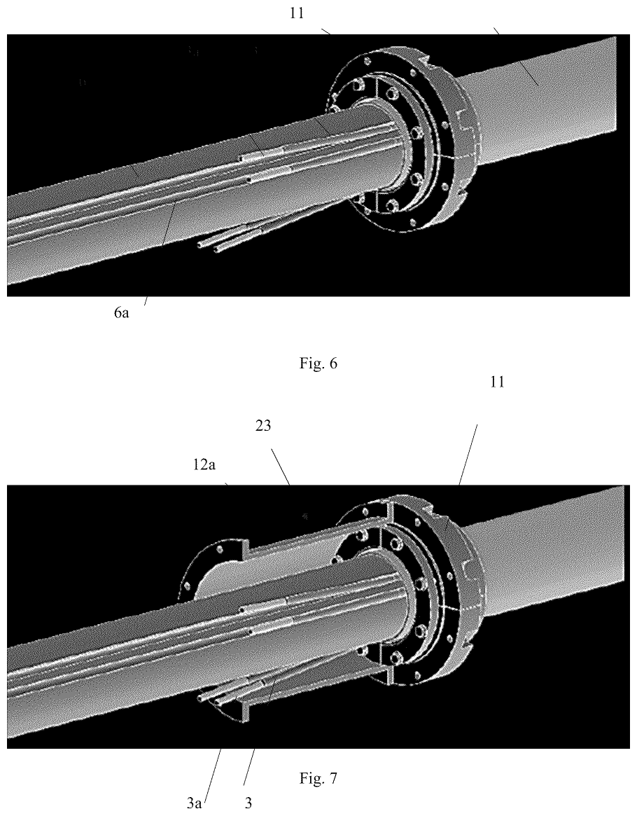

FIG. 6a illustrates the pulling out of rods 3 from the cable or umbilical 1. The figure illustrates the power cable or umbilical 1 in FIG. 1 and thus shows five rods 3 as described earlier. However, this is not limiting for the invention, any suitable number is possible as long as the rods 3 in total have enough strength to maintain the power cable or umbilical 1 in the pull in tool 10 during an installation process.

The rods 3 are further cut and threaded with an electrical hand tool or prepared for fastening by other preparation tool. (The hand tool is known per se)

FIG. 7-9 shows further the installation of a load bearing arrangement 23. The load bearing arrangement 23 may comprise a first and second lower cannister part 12a, 12b attached to the lower packer ring 11 and further assembled. The assembled lower cannister parts 12a, 12b are hereinafter referred to as lower cannister 12. The lower cannister parts 12a, 12b may preferable be connected staggered with respect to the packer ring parts 11a, 11b. The lower cannister 12 is enclosing the power cable 1 at the side facing the free end 1a. This means that the lower cannister 12 is enclosing a part of the power cable 1 where the sheath 4 has been removed.

The load bearing arrangement 23 may further comprise a load ring 13. The load ring 13 is installed between the lower cannister 12 and the power cable or umbilical 1.

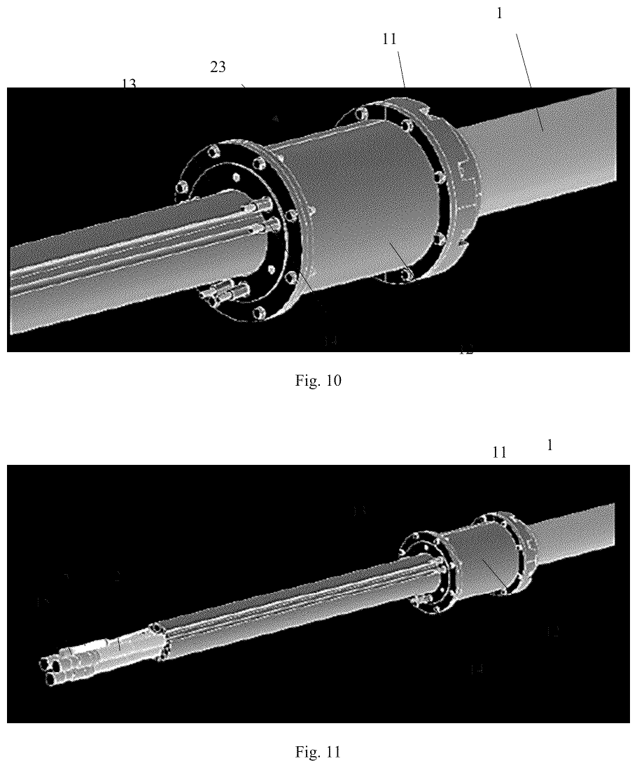

This is illustrated in FIG. 9. This figure further illustrates that the threaded rods 3 are mated with the load bearing arrangement 23. In this embodiment the rods 3 extends through openings 13a in the load ring 13. It is further shown that the cutting and threading process is performed in a distance so that the length of the rods 3 allows the rods 3 to extend in a distance out from the load bearing arrangement 23 or the openings 13a.

It is necessary that the rods 3 have this length so that a fastener 14 such as a nut can attach the rod 3 to the load bearing arrangement 23 or load ring 13. The attachment of fastener or nut 14 is illustrated in FIG. 10. There is shown a nut 14 screwed onto each threaded rod part 3a, respectively.

The fastening means using threaded portion of the rods 3 that is secured to the load bearing arrangement 23 through a respective nut 14 is the preferable option. However, other fastening means are also possible for fastening the power cable or umbilical 1 to the pull in tool 10. The fastening means may for instance also be performed by gluing the rods 3 to the load bearing arrangement 23. Another possibility is to weld the rods and the load bearing arrangement 23 together. Preferably, the parts of the rods 3 extending through the openings in the load ring 13 are in these embodiments glued or welded directly to the load ring 13.

Further, there is arranged a sealing device 15 for instance a boot seal onto each component that requires protection against water ingress during the lifting operation. These components may for instance be the power core 1 and the fiber optic cable 5. The sealing device 15 is arranged at the free end of the components 1, 5 as shown in FIG. 11.

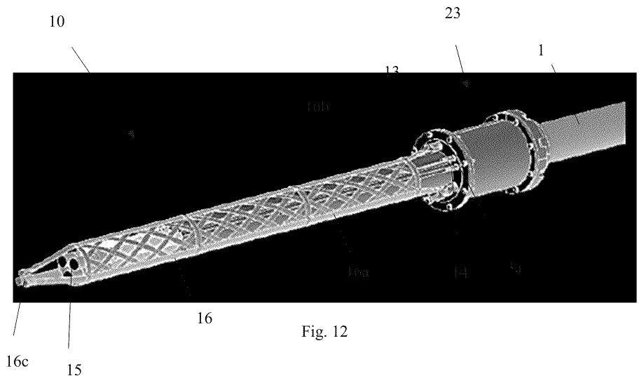

FIG. 12 shows a lifting device 16 of the pull in tool 10. This may be a pull in sling as shown, comprising a grid pattern 16a adapted to surround the exposed free end of the cable 1a. It further may comprise longitudinally extending lines 16b disposed around the grid pattern 16a. The longitudinal lines are connected in one end to the load bearing arrangement 23. In the other end, the lines 16b are connected together to form a loop 16c suitable for lifting. The pull-in sling provides the pull-in load to the cable or umbilical 1 in the lifting process. It also guides the free end 1a through the J-tube.

In the figure, the pull in sing 16 is connected to the load ring 13.

The fastening and pull in tool 10 comprise in its simplest design a packer ring assembly 11 for connection with the power cable or umbilical 1, a load bearing arrangement 23, fastener 14, 3a for attaching the rods 3 of the power cable or umbilical 1 to the load bearing arrangement 23. The tool 10 further comprises a lifting device 16 for protecting the components of the power cable or umbilical 1, provide an easy movement of the power cable or umbilical 1 through a J-tube and facilitate the lifting operations. J-tube is common practice in the offshore industry. It is a tube that is shaped as an J that extends from the seabed to the topside of the offshore facility.

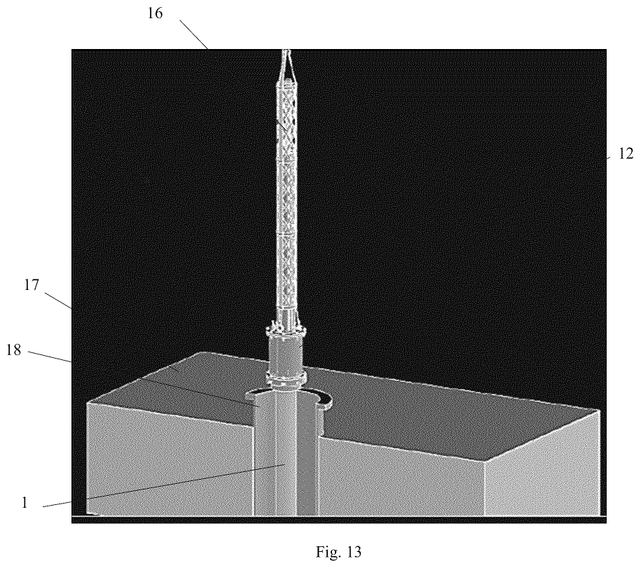

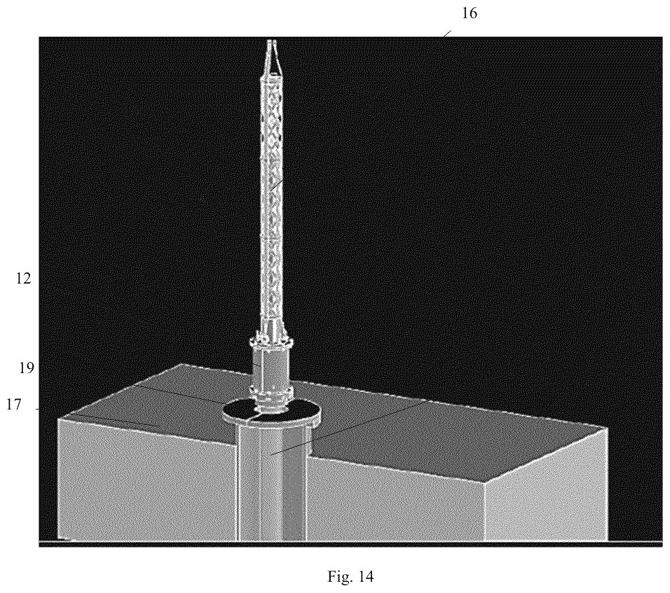

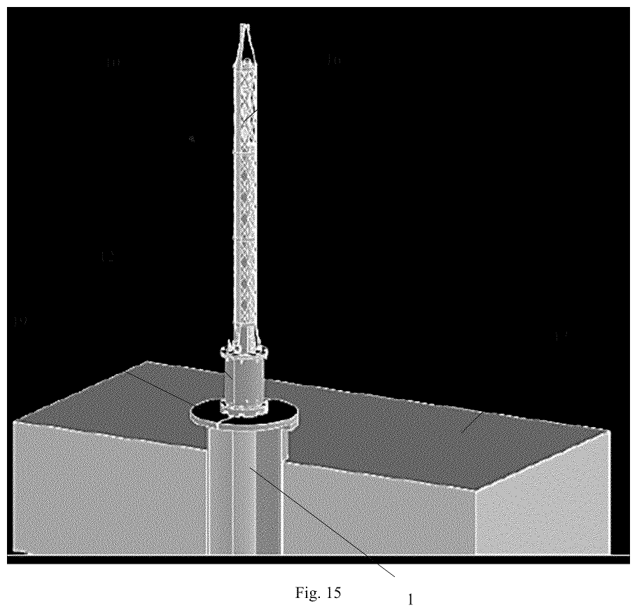

FIG. 13-20 shows a method for using the pull in tool 10 according to the invention for installing the power cable or umbilical 1 at the offshore facility.

FIG. 13 illustrates the power cable 1 pulled through a J-tube reaching the top of an I-tube 18 on an offshore facility 17 using the pull in tool 10 according to the invention. The pull in tool 10 is particularly suitable to be used for the pulling through J-tubes.

However, the invention is not limited to the pulling through a J-tube. Other lifting and installation processes for installation of power cable or umbilical 1 are possible embodiments of the invention. This may for instance be through I-tube, open air or through open seawater.

FIGS. 14 and 15 shows the sequential steps of installing of a split hang off flange 19 on top of the I-tube 18 and landing the power cable or umbilical 1 on the I-tube 18.

This is performed by landing the load bearing arrangement 23 onto the split hang off flange 19.

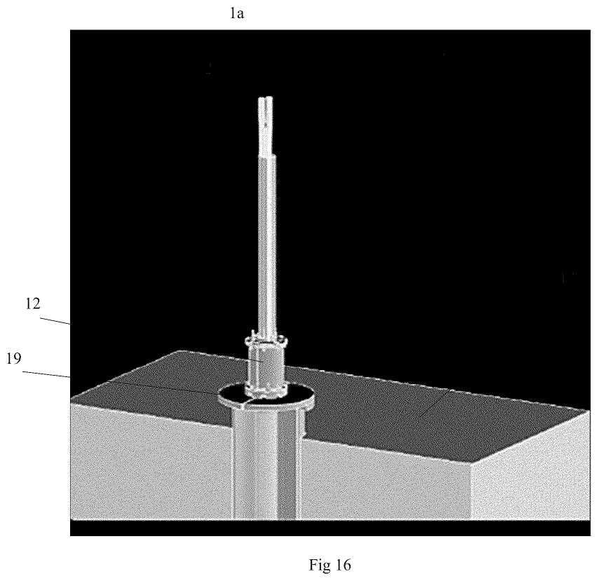

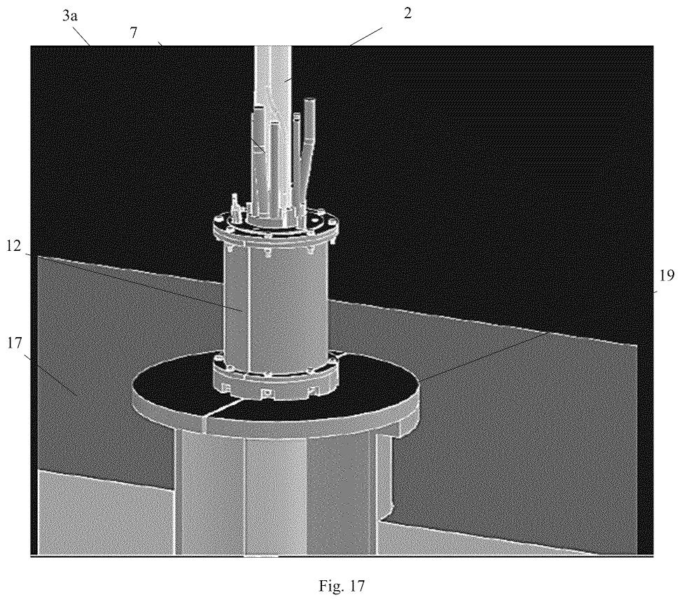

After the power cable or umbilical 1 is installed, the pull in sling 16 is removed, as illustrated in FIG. 16. In addition, the remaining filler material 6 from the load bearing arrangement 23 and the free end 1a is removed.

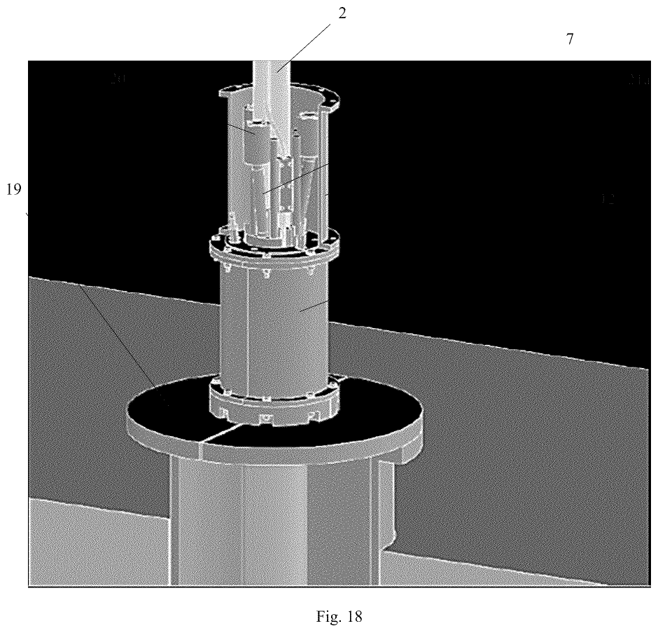

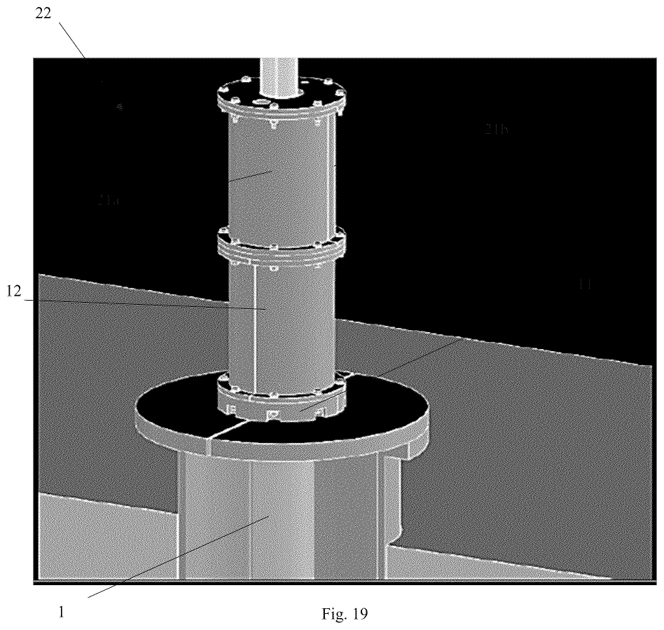

Further, as disclosed in FIG. 17, the strands 7 are cut back to a required length. These represents the main load bearing elements and it there preferred that these are cut to a shorter length. The strands 7 are further prepared for installation of spelter sockets 20. The installation of spelter sockets 20 around the strands 7 are shown in FIG. 18.

The last step of the installation process is shown in FIGS. 18 and 19 where a first and second upper cannister 21a, 21b is connected onto the lower cannister 12. The first and second upper cannister part 21a, 21b are further assembled together into an upper cannister referred to as 21. As shown in FIG. 19, the length of the strands 7 are now less than the length of the upper cannister 21. The upper cannister 21 will thus completely enclose the end parts of the strands 7. The upper cannister 21 being molded in order to provide a strong connection for the power cable in the suspended position.

This also represents the finish of the permanent termination of the power cable or umbilical 1 on the offshore facility.

In shallow water, there is however a possibility to complete the permanent termination without the upper cannister and molding as the power cable umbilical 1 is exposed to less forces in these environments.

1. A temporary fastening and pull in tool for a power umbilical adapted to be installed at an offshore facility, such as a wind generator facility, the power umbilical has an outer sheath surrounding at least one power core and at least two rods, the tool comprising:
a packer assembly for sealing and to give mechanical support around a portion of the sheath situated at or near a free end portion of the power umbilical;
a load bearing arrangement connected to the packer assembly adapted to receive an end portion of the at least two rods;
a fastener adapted to secure each rod to the load bearing arrangement; and
a lifting device attached to the load bearing arrangement for guiding the power umbilical to the offshore facility and ease the pull in operations of the power umbilical.

2. The temporary fastening and pull in tool according to claim 1, wherein the fastener is a nut adapted to mate with a threaded end portion of each rod, respectively for securing the at least two rods to the load bearing arrangement.

3. The temporary fastening and pull in tool according to claim 1, wherein the load bearing arrangement comprises a lower cannister attached to the packer assembly.

4. The temporary fastening and pull in tool according to claim 1, wherein the load bearing arrangement comprises a load ring with at least two openings adapted to receive respectively the rod ends, the load ring being situated inside of the lower cannister.

5. The temporary fastening and pull in tool according to claim 1, wherein the lifting device comprises a pull-in sling having a grid pattern adapted extend around the power umbilical at a free end in an area where the sheath has been removed from the power umbilical.

6. The temporary fastening and pull in tool according to claim 1, wherein the tool further comprises a sealing device adapted to be connected to the free end of the power cores and/or a fiber optic cable to prevent water ingress during the lifting operation.

7. A method for assembling the temporary fastening and pull in tool to perform a temporary pull in operation according to claim 1, wherein the method comprises the following sequential steps
removing the outer sheath from a free end portion of the power cable,
installing the packer assembly around a portion of the sheath situated at or near the free end portion of the power umbilical,
attaching the load bearing arrangement to the packer assembly at the side facing the free end portion,
preparing the at least two rods for attachment to the load bearing arrangement,
securing the at least two rods to the load bearing arrangement,
installing a sealing device on the power core(s) and/or a fiberoptic cable arranged within the power umbilical to prevent water ingress, and
attaching a lifting device to the load bearing arrangement and lifting the power umbilical with the pull in tool.

8. The method according to claim 7, wherein the method further comprising the step of removing the outer sheath up to five meters from a free end of the power umbilical prior to installing the packer ring.

9. A method for permanently termination of a power umbilical in an offshore facility, such as an offshore wind generator, using the temporary fastening and pull in tool according to claim 1, wherein the method comprises
pulling-in the power umbilical to a tube where the power umbilical is adapted to be suspended,
installation of a hang off flange for permanently suspension of the power umbilical, and
removal of the lifting device and cutting back components of the power umbilical, such as strands and filler material.

10. The method according to claim 9, wherein the method further comprises the step of pulling-in the power umbilical through a subsea tube, such as a J-tube to a tube where the power umbilical is adapted to be suspended.

11. The method according to claim 9, wherein the method further comprising the steps of
arranging spelter sockets around respective end strands,
arranging an upper cannister to the load bearing arrangement, and
filling casting material into the upper cannister.
